(19) United States
(12) Patent Application Publication
(10) Pub. No.: US 2005/0132406 A1
(43) Pub. Date: Jun. 16, 2005

(54) Echo channel for home entertainment systems

(76) Inventor: Yuriy Nesterov, Miami, FL (US)

Correspondence Address: Yuriy Nesterov, 16851 NE 23 Ave., # B 321, North Miami Beach, FL, 33160, US

(21) Appl. No.: 11/005,279

(22) Filed: Dec. 6, 2004

Related U.S. Application Data
(60) Provisional application No. 60/529,338, filed on Dec. 12, 2003.

(51) Int. Cl. H04N 7/16; G10L 21/00; G10L 19/00; H04R 5/02; H04N 7/18; H04H 9/00

(52) U.S. Cl. 725/74; 725/78; 725/18; 381/300; 381/303; 381/307; 704/500

(57) ABSTRACT

An echo channel for home entertainment systems is an additional channel. The echo channel for home entertainment systems is a new component for creating echo effects in small rooms. By using sound delaying methods and apparatuses, echo effects of the home movies are created. These echoes are generally replica of the echoes which naturally exist in the movie theaters. So, listeners, can enjoy echoes in small rooms, and have feelings as if he or she is in the movie theater. Also, the echo channel is for compensation the missing effect of the movies, when humans are watching movies in small rooms at a low volume.

### FIELD OF INVENTION

This application claims the benefit of PPA Ser. No. 60/529338, filed Dec. 12, 2003 by the present inventor.

### SEQUENCE LISTING

Not applicable.

### FIELD OF INVENTION

This invention pertains to the art of methods and apparatuses audio signal conditioning and more specifically to home entertainment systems and sound delaying modules.

### BACKGROUND OF THE INVENTION

Cinematography was one of the major discoveries of the last century. It made a huge influence on our lives. Cinematography become an inseparable part of our lives. During evaluation of the “picture,” the sound of the movies has changed dramatically. It is not only that stereo and multiple channels audio was introduced, but also special effects sound recording was implemented. Even though sound is now far from “real sound”, but this enriched, enhanced by special effects and multi-channeled sound pleased our ears. In the recent years, home entertainment systems become more and more popular. Many families have entertainment system and can enjoy watching movies at home. Also with the development of digital technologies, quality of the video and audio signals continue to improve. Mostly all the sound effects and wide screen movie pictures are now possible to enjoy in our homes. All the special effects which we can experience in the movie theaters are now digitized and modified for home entertainment systems. Audio and video processors of home systems can have multiple audio channel readers as well as wide screen monitor.

Although the best of the digital technologies are available for public use, still audio experience in home is not the same as feelings we experience in the movie theaters. Mostly when we watch movie for the first time and it happens in the movie theaters, unconsciously we hold to the audio and video effects from watching movie in the movie theaters. We hold to this impression and want to experiment the same feelings at home. We want to watch movies at home but feel as if we are in the movie theater. Seems like we get everything: popcorn, soda, wide screen monitor, digital sound processor, multiple speakers, but it still does not feel the same as in the movie theater. It is a big video difference and huge audio-gap between movie theater effects and home entertainment system. As home systems are getting more complex and expensive, they are still far from reproducing movie theater effects in small rooms of our homes. Sound receivers vary in price and technical characteristics. Even though all of them give good and some even very good sound, but none of them can produce effects of the movie theater. Generally using the same soundtrack at home as in the movie theaters, we do not feel the same effect as in the movie theaters. We can spend a lot of money on special speakers but it is still not the same sound, not the same feelings as in the movie theaters. Mostly it is a problem to play a movie in home at a loud volume. Although a movie sound track is the special sound recording, it is difficult to reproduce the same effect as in the movie theaters. In order to deliver all the effects of the soundtracks, it has to be played very loud. It is most of the time impossible to play a movie loud because of children, neighbors, after 11 pm restrictions, sick people, or you just want to have a romantic time. Then the movies sound tracks played at a low volume most of the effects are lost.

Accordingly, there are several objects and advantages of my invention.

Now we can have all the technology of the movie theaters in our homes in form of home entertainment system. These digital home systems reproduce exceptional quality sound except one thing. This one thing is a naturally occurred echo in the movie theaters. Mostly due to the size of the movie theaters multiple reflections of the sound occurs. These echoes of the movie theaters make the big difference in the sound in comparisons to the home entertainment systems. Although the most of digital sound recording is now introduced for the public use, still something is missing. This very important detail which is missing in our home entertainment systems is an echo. This is the echo which naturally exists in the movie theaters. In order to fill up our homes with sound quality equal to those as in the movie theaters, the echo channel for homes entertainment systems is needed. The echo channel generally means: taking a sound of the home system, delaying it for a fraction of time, and then playing it back with original sound. By introducing this process and apparatuses human can enjoy echoes, similar to the movie theaters, in small rooms. Sound delaying machines can produce basic echoes as well as very sophisticated echoes. Some sophisticated sound delaying machines can mimic echoes of the movie theaters, by playing them in our homes, in combination with the home entertainment system. Thereby, by using sound delaying apparatuses for creating echoes, human listeners can enjoy echoes of the movie theaters in their homes. Having echoes in our homes can simulate sensations of the movie theaters. Having echoes in small rooms can make sound richer, more exciting, bring the movie action more close, sinking human into the action, intensify and sharpen our sensations.

Another advantage of having “The echo channel for home entertainment systems” is an enrichment of sound at a low volume. It is a known fact that loud sound is causing health problems. Also, because of neighbors, or 11 pm restrictions, or small children, or sick people, or maybe a desire of having peaceful romantic time, it is impossible for humans to have a loud sound. Thereby, by delaying sound and playing it back with original sound will create echo. This echo can make sound to be richer and deeper even though the volume of the sound is low. This is advantageous for small rooms and especially for our homes. By adding “The echo channel” to home entertainment systems human listeners can enjoy sound of the movies in a moderate volume but rich and deep. Also, adding the echo channel to the home entertainment system will allow to compensate missing effects, when the volume of the movie sound is low. The echo effect will fill up a small room with deep sound at a low volume. Now human listeners can enjoy watching movies with rich and deep sound at a low volume.

### SUMMARY

The echo channel for home entertainment systems is an idea of using methods and apparatuses for creating echoes in conjunction with home entertainment systems, thereby, giving human listeners the opportunity to enjoy echoes, similar to echoes of the movie theaters, in small rooms. Also, compensating missing audio effects at a low volume by adding echo channel to home entertainment systems.

### BRIEF DESCRIPTION OF THE DRAWINGS

FIG. 1 is a schematic representation of a practical use of an echo channel.

FIG. 2 is a schematic representation of an echo channel in conjunction with a home entertainment system.

FIG. 3 is a schematic representation of the audio receiver, of the home entertainment system, having the echo channel.

FIG. 4 is a perspective front view of a movie signal processing apparatus showing echo channel switch on its face.

FIG. 5 is a schematic representation of a method of adding echo effects to movies storing media.

FIG. 6 is a schematic representation of the television having an echo channel.

FIG. 7 is a perspective side view a sound delaying apparatus.

FIG. 8 is a perspective front view of a sound delaying apparatus.

FIG. 9 is a perspective view of a sound delaying apparatus as it is positioned behind a wall.

### FIRST EMBODIMENT

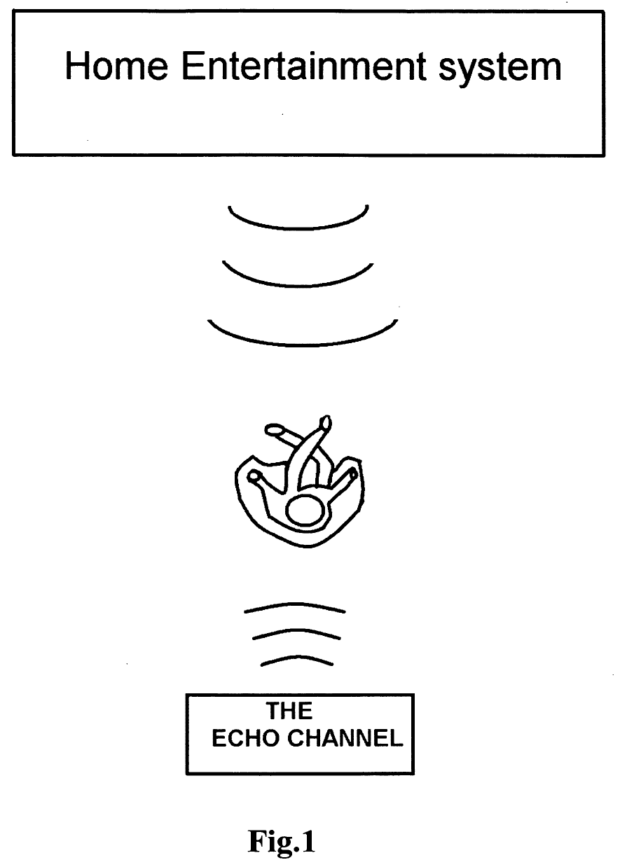

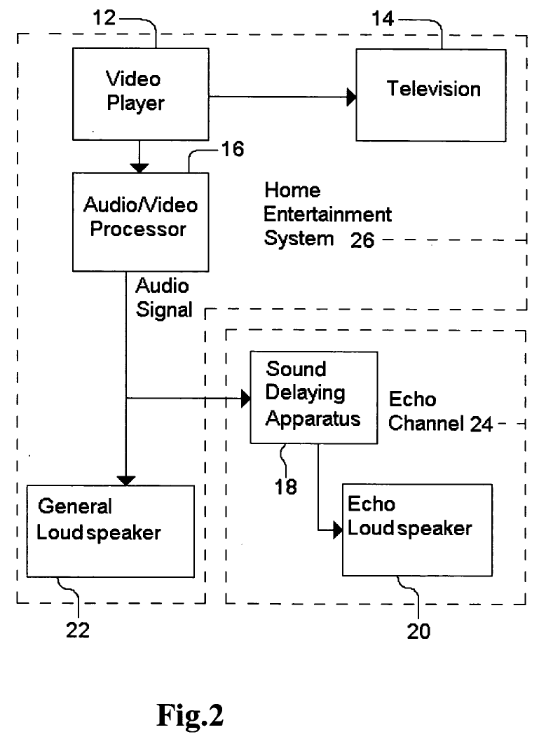

FIGS. 1 and 2 show a home entertainment system 26 in conjunction with an echo channel 24. Home entertainment system 26 is generalized example of entertainment systems. System 26 includes a video player 12, a television 14, an audio/video processor 16, and a general loudspeaker 22. The echo channel 24 includes a sound delaying apparatus 18 and an echo loudspeaker 20.

The home entertainment system expresses all known audio and video apparatuses for home entertainment. This system may have different forms and combinations but general purpose is for providing audio and video processing. The echo channel is a new component. The echo channel is an audio device which is an addition to home entertainment systems. In the echo channel 24 sound delaying apparatus 18 expresses general purpose of delaying audio signal. Thereby, the echo channel can work in harmony with home entertainment system and deliver new audio experience to human listeners.

Video player 12 transmits video signal to television 14. Audio signal transmits from player 12 to audio/video processor 16. Simultaneously, processed audio signal from processor 16 transmits to general speaker 22 and to sound delaying apparatus 18. Audio signal is delayed by apparatus 18 and transmitted to loudspeaker 20 fusion of original sound and delayed sound creates the echo effect.

Television 14 receives video signal from player 12 and provides human with visual experience. Audio signal is directed to general speaker 22 and at the same time to the echo channel. Original and delayed sounds in combination provide human listener with echo type audio experience. Now human can enjoy watching movies which have deepened and enriched sound because of the echo effect. This echo effect can compensate the missing audio effects at a low volume.

Also, the echo channel is here for creating echo effects similar to those of the movie theaters. The echo channel brings new effect in our homes. Now humans can watch movies at home and have feelings as if he or she is in the movie theater. Fusion of the echo channel with home entertainment system is expanding video and audio sensations of the listener. The echo channel gives opportunity to enjoy echoes of the movie theaters in small rooms.

### SECOND EMBODIMENT

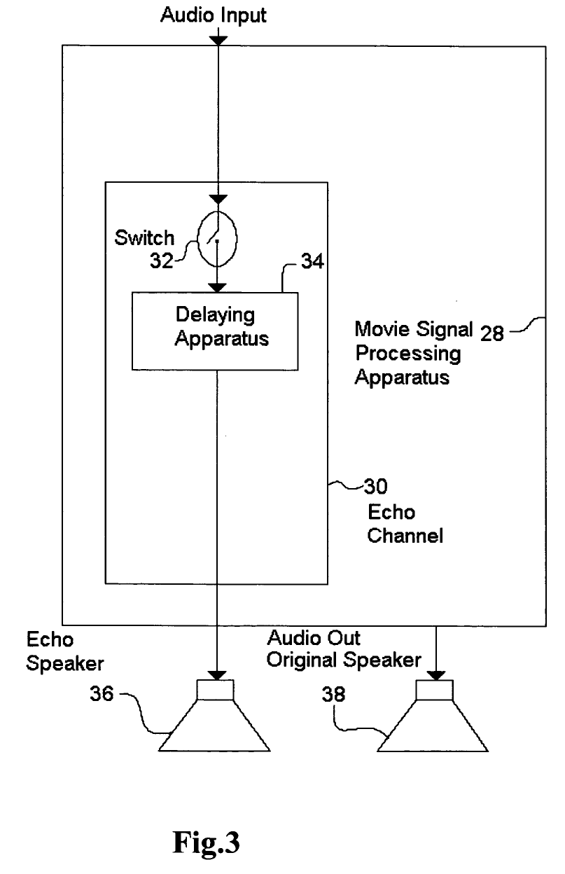

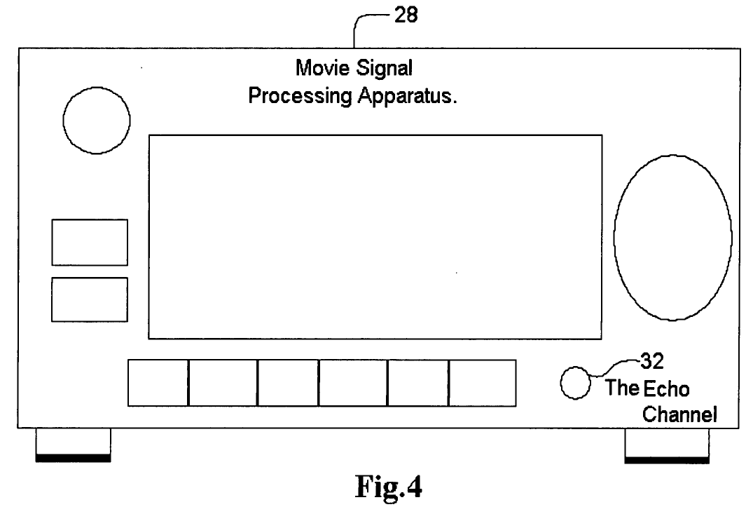

FIG. 3 and FIG. 4 show a movie signal processing apparatus 28 having an echo channel 30. Echo channel 30 represents generalized sound delaying methods and apparatuses. The echo channel includes a switch 32, a delaying apparatus 34, and an echo speakers 36. As it shown in FIG. 4 the movie signal processing apparatus has adapted the echo channel. Switch 32 is for turning on the echo channel. Processing apparatus 28 includes an original speaker 38. The speaker 38 represents generalized multichanneled speakers of the home entertainment system.

Processing apparatus 28 receives audio signal for its processing. At the same time audio signal is directed to echo channel 30. Switch 32 opens passage for audio signal for delaying process by delaying apparatus 34. Audio signal is processed by delaying apparatus 34 into a simple or complex form. Delaying apparatus 34 represents generalized audio signal delaying methods and audio signal delaying apparatuses. Simplicity or complicity of delaying apparatus 34 depends on desirable audio outcome. Processed signal from the delaying apparatus is directed to the echo speaker, at the same time echo speaker converts delayed audio signal into audible signal, the original speaker converts original audio signal from processing apparatus 28 into audible signal. This simultaneous sound outcome from speaker 38 and 36 produces an echo effect.

Different echo types can give human listeners different audio experiences. By using short time delay the echo will enrich sound. This type of echo is mostly for compensating missing audio effect of the movies at a low volume. Human listeners can enjoy deepened and enriched movie sound at a low volume. Another echo type is focused mostly on simulating echoes of the movie theaters. The echo channel can reproduce naturally occurring echoes of the movie theaters in small rooms in our homes. Now humans can watch movies at home and feel as if he or she is in the movie theater. Humans can experience richer and deeper sound which brings sensations of expansion small room into huge space of the movie theater. The echo effects can be selected and adjusted by the echo channel, as well as by apparatus 28 for personal human listener habits.

### THIRD EMBODIMENT

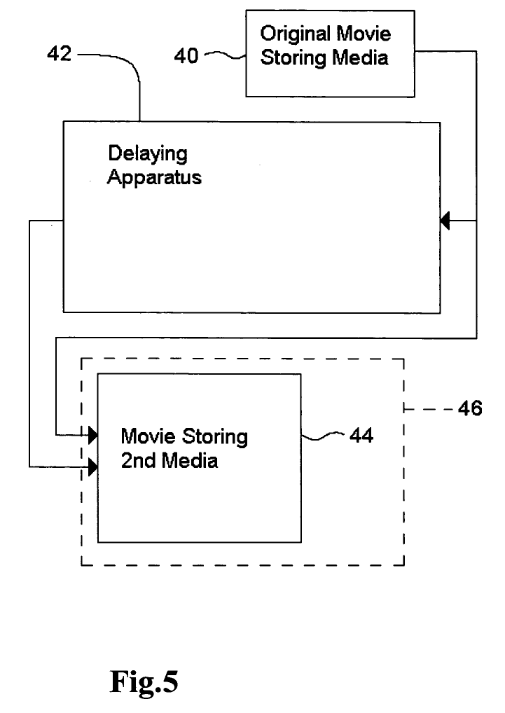

FIG. 5 shows a method of adding echo effect to movies storing media. For fulfilling the process an original movie storing media 40, a delaying apparatus 42, and movie storing 2^{nd} media are needed. FIG. 5 shows principal concept which can be broken into more sophisticated and complex construction, but the final result will be the same as it is described in this application.

Delaying apparatus 42 can be the most sophisticated machine. Apparatus 42 receives audio signal from original movie storing media 40. Apparatus 42 delays audio signal in from it needed for the final result. This delayed signal is directed to 2^{nd} media 44 where the delayed signal is recorded with original movie signal, whereby producing a storing movie media with echo effects 46.

Apparatus 40 is for delaying audio signal in the same fashion as audio signals naturally delayed in the movie theaters. Apparatus 40 creates delayed signals, similar to naturally delayed signals in the movie theaters, media 44 is for adding delayed signal to original sound track, storing media 46 is the storing movie media with echo effects. The echo effects can be selected by human listener as desired or not to be played depending on the listener habits. When the echo channel is selected, human listeners can enjoy echo effects similar to the echoes in the movie theaters in small rooms. By playing storing media 46 human listeners can watch movies at home and experience feelings as if he or she is in the movie theater. Storing media 46 gives listener advantage to enjoy echo effects, similar to existing in the movie theaters, in small rooms in our homes. This new effect in our homes becomes possible due to adding echo effects to original movies soundtracks.

### FOURTH EMBODIMENT

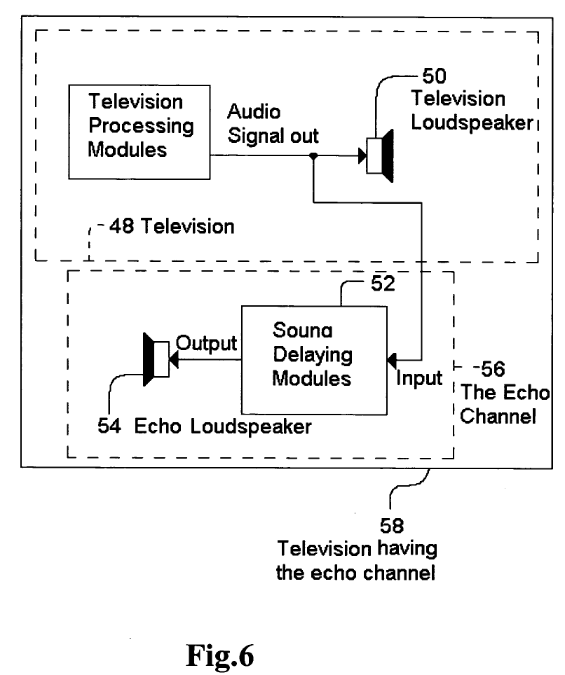

FIG. 6 shows a television 48 having an echo channel 56. Television 48 has a television loudspeaker 50. Echo channel 56 includes an echo loudspeaker 54 and a sound delaying modules 52. The television sends its audio signal to loudspeaker 50 and to sound delaying modules 52. Sound delaying modules 52 sends delay signal to loudspeaker 54.

Simultaneously audio signal from the television directed to speaker 50 and delaying modules 52. Delaying modules 52 delays signal and outputs it to speaker 54. Whereby speaker 50 and speaker 54 in combination are producing echo effects. The main purpose of the echo channel is to delay sound for a time of a range of 0.02-0.09 of second. By delaying sound for such a short time as 0.02 to 0.09 of second will create softly echo background and make the sound deeper and richer. Also, by using more complex and longer delaying time echo channel 56 can reproduce echoes similar to echoes of the movie theaters. Now human listeners can have more choices and enjoy soft echoes in small rooms, in our homes.

### FIFTH EMBODIMENT

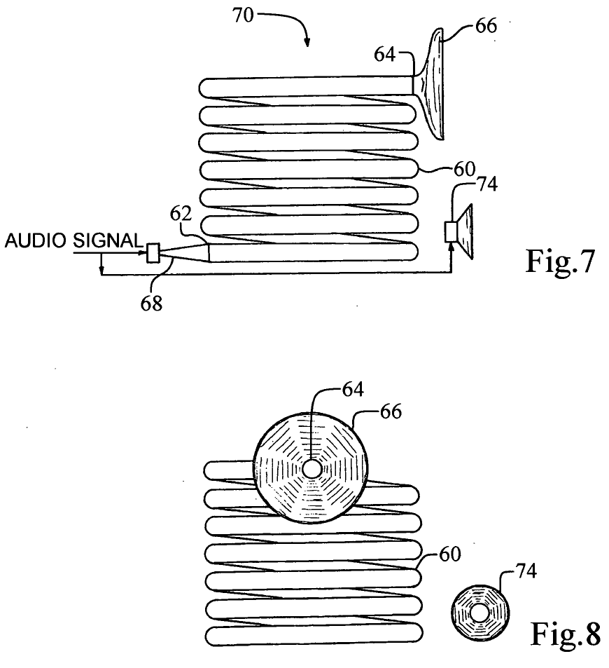

FIGS. 7 and 8 show a sound delaying apparatus 70. Delaying apparatus 70 includes a hollow elongated structure 60, an amplifier 66, and a loud speaker 68. The hollow elongated structure having a sound receiving opening 62 and a sound emission opening 64, thereby structure 60 is for sound passage in limited boundaries and specific direction. Opening 62 is for receiving sound from loudspeaker 68 and opening 64 is for emission of sound. Speaker 68 is for converting audio signal in to sound and amplifier 66 is for amplification of emissioned sound.

Speakers 62 is connected to opening 62, whereby sound from speaker 62 is forced through hollow elongated structure 60. Sound is passing through structure 60 and exiting through opening 64. Amplifier 66 is connected to opening 64, whereby amplifier 66 is amplifying emissioned sound. Opening 62 and opening 64 positioned in a plane which always less than length of the structure 60, whereby structure 60 is delaying sound. Sound delaying apparatus 70 is for delaying sound and using it in combination with original sound of an original loudspeaker 74, whereby creating an echo effect.

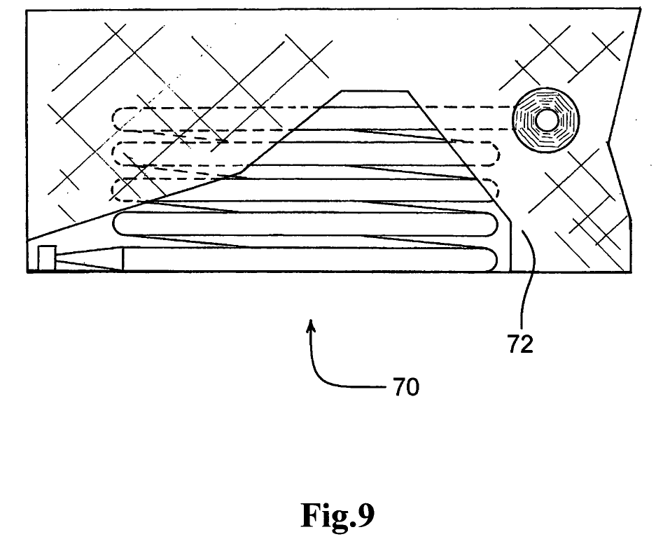

As shown in FIG. 9, sound delaying apparatus 70 can have different shapes and forms. Delaying apparatus 70 can be placed behind a wall 72, and particularly between home walls. By placing apparatus 70 between walls will save room space.

Apparatus 70 is an alternative to all other delaying machines. By using apparatus 70 in combination with home entertainment systems, listener can enjoy echo effects. It is advantageous having echo effects in small rooms. The echo effects fills small room with richer and deeper sound.

1. An echo channel for home entertainment systems comprising: sound delaying methods and apparatuses added to home entertainment systems; means in combination producing echo effects when watching and listening movies in small rooms.

2. The echo channel in accordance with claim 1, is an additional component for home entertainment systems.

3. The echo channel in accordance with claim 1, comprising: means for generating said echo effects similar to echo effects of the movie theaters.

4. The echo channel in accordance with claim 1, comprising: means for creating a replica of echo effects which naturally occurring in the movie theaters.

5. The echo channel in accordance with claim 2, said additional component for home entertainment systems; comprising: means for delaying audio signal of the home entertainment systems.

6. The echo channel in accordance with claim 5, is receiving signal from the central channel of the home entertainment systems.

7. A method for replicating echo effects of the movie theaters in small rooms comprising the steps:
(a) delaying a movie audio signal, and
(b) delivering said delayed signal in combination with the original movie signal, whereby creating said echo effects.

8. Said echo effects as recited in claim 7, are generally a replica of naturally occurring echoes in the movie theaters.

9. An echo channel for home entertainment systems, comprising: an audio and a video signals processor is incorporated a sound delaying apparatus; means for creating echo effects, whereby human listeners can enjoy echoes in small rooms.

10. The echo effects as recited in claim 9, wherein are generally a replica of echoes which are naturally occurring in the movie theaters.

11. Said audio and video signal processor is incorporated said sound delaying apparatus as recited in claim 9, further comprising: means for simulating echoes, similar to those which are inevitably occurring in the movie theaters, in small rooms in our homes.

12. An echo channel for home entertainment system, comprising: a storing movie media having a delayed audio signal in addition to an original signal, whereby means in combination said original signal and said delayed signal for producing echo effects.

13. The echo channel as recited in claim 12, wherein can be selected if it is needed.

14. Method for creating a movie storing media having echo effects which are replica of the echoes naturally existing in the movie theaters, comprising the steps:
(a) delaying original movie audio signal by using delaying methods and apparatuses, and
(b) recording delayed audio signal and original movie signal to a movie storing media, whereby means delayed audio signal and original movie signal in combination for creating echo effects.

15. A television having an echo channel, comprising: the television, a sound delaying modules and an echo loudspeaker, means in combination for producing echo effects.

16. A method for creating an echo effects in small rooms by delaying sound of the home movies, comprising the steps:
(a) delaying movie sound, and
(b) playing said delayed sound with original sound, whereby creating echo effects.

17. A sound delaying apparatus, comprising: a hollow elongated structure, whereby shaped specifically for sound delaying.

18. Said hollow elongated structure of claim 17 wherein having two openings.

19. said hollow elongated structure of claim 17 wherein is shaped, that a distance between said two openings always less than total length of the hollow structure.

20. The two openings of claim 18, comprising means:
(a) first means one opening for receiving sound
(b) second means second opening for emitting of sound

21. The two openings of claim 18, farther comprising: one opening having loudspeaker, and second opening having amplifier.

22. Said sound delaying apparatus of claim 17, wherein is positioned behind a wall.
